(19) United States
(12) Patent Application Publication
(10) Pub. No.: US 2012/0329009 A1
(43) Pub. Date: Dec. 27, 2012

(54) Two-part implant system for anchoring dental prostheses

(75) Inventor: Armin Nedjat, Flonheim (DE)

(73) Assignee: CHAMPIONS-IMPLANTS GmbH, Flonheim (DE)

(21) Appl. No.: 13/412,349

(22) Filed: Mar. 5, 2012

(30) Foreign Application Priority Data
Mar. 4, 2011 (DE) 10 2011 013 093.4

(51) Int. Cl. A61C 8/00

(52) U.S. Cl. 433/174

(57) ABSTRACT

It is the purpose of the implant system according to the invention to reduce the danger of the entry of infections into the implant and to achieve a simplification relative to the structural components that are used.

An implant system is disclosed in which during the first process step of the insertion of the implant base, a gingiva former is already mounted on this base by means of an inside screw. This means that the basic starting component is the implant with a gingiva former that is already attached to the implant for screwing into the jaw. The gingiva former now has—both via a special shaping—the anti-rotation, positive contact with the implant threading and a top-side accommodation with inside shaping, which makes it possible to mount a screw tool into this gingiva former.

The invention relates to a two-part implant system for anchoring dental prostheses according to the preamble of the main Claim 1.

It is known in the state of the art to attach dental prostheses permanently in a patient's jaw by an interaction of several structural components and a multi-stage implantation method. In the state of the art, in this connection, for example, a hollow externally threaded implant body is screwed into the jaw using a special tool. In this connection, this is a fastening body that can be designed in such a way, for example, that it has a first wider threaded form in the lower section and has an additional microthreaded structure in its upper section.

In conventional implantation methods, after this implant body is inserted into the jawbone, the implant body is closed by a cover screw to prevent the penetration of germs. This first design remains in the patient's jaw for a defined time period without further work in order to make possible a first stabilizing ingrowth into the jawbone.

At a second appointment, this cover screw is re-detached from the threaded body, and in its place, a so-called gingiva former is mounted to prepare the gum to receive the later dental prosthesis body. In this process, this gingiva former is already based in its shaping on the later-mounted artificial dental body and produces a corresponding molding of the gum in this area.

At a third treatment appointment, an impression is now made in which the gingiva former is replaced by a so-called impression post, so that in the dental laboratory, the position of the later dental prosthesis in the jaw can be adjusted, and the artificial dental prosthesis can be prepared for mounting on the implant.

This last step is now carried out at the fourth appointment, in which the dental prosthesis that is pre-fabricated in the dental laboratory is now mounted. In this respect, a so-called abutment is mounted for the first time on the screwed-in implant body and screwed into the implant. Now, in the last working step, the artificial dental prosthesis is finally mounted on this abutment.

In this connection, it is clear that this is an expensive procedure with a large number of working steps, whereby once in a while, it is essential that between the individual working steps, a certain adaptation time is necessary, in particular for the stabilizing ingrowth of the implant body into the jaw, to prevent the latter from becoming loose in the jaw again during further work on the implant body.

The method that is performed in such a way has the drawback, moreover, that because of the frequent changing and mounting on the externally threaded implant body, the danger of the entry of germs is considerable, which can trigger infections.

It is therefore the purpose of the implant system according to the invention to propose a solution that produces clear simplifications in particular for the implant process, i.e., the method of the insertion of the implant base until the dental prosthesis is inserted. Moreover, the implant system as well as the method are to reduce the danger of the entry of infections into the implant. Finally, it is also to be achieved that a simplification can be achieved relative to the structural components that are used.

To accomplish this object, an implant system with the concentrated features of Claim 1 is disclosed. In this connection, the subclaims have advantageous configurations of the basic system.

In addition, a method for use based on the newly configured implant system is claimed.

In this connection, basic alteration in the configuration of the implant is that during the first process step of the insertion of the implant base, a gingiva former is already mounted on this base by means of an inside screw.

This means that the basic starting component is not only the externally threaded implant, but rather the implant with a gingiva former that is already attached to the implant for screwing into the jaw.

Here, in particular, a new configuration of the mounted gingiva former is carried out, which now has—both via a special shaping—the anti-rotation, positive contact with the implant threading and a top-side accommodation with inside shaping, which makes it possible to mount a screw tool in this gingiva former.

This means that a basic new approach consists in that the process of screwing the implant into the jawbone is usually not done as before just by screwing in the externally threaded implant body, but rather that this implant body is already connected to the gingiva former by a retaining screw that is guided into the implant in an internal threading.

This has several advantageous aspects. On the one hand, it is possible, during the insertion process of the implant, to insert the latter directly with gingiva former through the opened gum of the patient into the jaw. In this way, with proper application, a subsequent mounting of the gingiva former and thus an optional penetration of germs can be avoided.

Another aspect is that the implant itself is already clearly stabilized by the mounted gingiva former and the fastening screw that thus is used in the sleeve-like implant. This means that the implant body that is designed as a hollow body is stabilized by the mounted gingiva former as well as the screw that runs therein and is secured against a possible deformation when being screwed into the jawbone. This is in particular clearly advantageous in the case of implant bodies of small diameter that are designed narrow, since the latter can be damaged by the stresses produced during the screwing process.

It is, moreover, a clear advantage that it is no longer necessary to wait for a healing phase of the implant to insert this gingiva former because of this design of the implant to be inserted with an already mounted gingiva former. This means that the gingiva former is mounted directly with the implant and the gum accordingly is spread around the gingiva former, without the latter first having to take place in a second working step. In this way, it is achieved that considerable time is saved compared to the previous method.

Another advantageous effect is that the internal threading of the implant is protected in this way and is not deformed by the more frequent removal of the fastening screw, so that the danger for the later connection screw abutment-implant body to become loose or even to break can be clearly reduced.

In this connection, the gingiva former, in an exemplary design, is designed on its lower section that engages in the implant with a hexagonal nut-shaped hexagonal outside contour, which can be inserted into a corresponding inside contour, designed as a negative in this case, in the upper section of the implant base. This means that the gingiva former is positively inserted by its approximately hexagonal nut-like outside contour on its lower end into the correspondingly shaped accommodation in the implant body. The final attachment is now done by a screw that extends through the gingiva former, which engages in an internal threading in the implant body and thus connects the gingiva former tightly to this implant.

In this way, it is now possible to undertake the process of screwing the implant body into the jaw by introducing force into the gingiva former. Owing to the outside contour of the gingiva former in the connecting area to the implant, which engages in the correspondingly formed accommodation on the inside of the implant body, the rotational movement that is necessary for screwing can be introduced via the gingiva former into the implant body. For this purpose, however, it is necessary, moreover, that the gingiva former in its upper accommodation also make possible a correspondingly positive engagement of a tool. In the exemplary design, this is achieved by an inside contour, also in approximately hexagonal nut shape, in the upper section of the sleevelike gingiva former, in which a tool can engage on the top side.

The gingiva former fulfills a third function as a holding body for an impression post, which is necessary for the impression for the production of the later dental prosthesis in the dental laboratory. For this function, it is provided that the gingiva former in the exemplary design has connecting means, for example a groove, which also runs on the inside within the upper accommodation of the gingiva former and corresponds to at least one engaging body, for example a rotating spring or a rotating projection, on the lower pin of the impression post engaging in the gingiva former.

In turn, here, the impression post has a lower-side connecting adaptor to the gingiva former, which has a special shape that corresponds to the top-side accommodation of the gingiva former. This means that the connecting adapter of the exemplary impression post also has an approximately hexagonal nut-shaped basic configuration that already engages positively in the corresponding accommodation of the gingiva former. The rotating spring, which now can be clicked into the upper section of the gingiva former during mounting of the impression post in the corresponding groove and thus makes possible a secure hold of the impression post in the gingiva former, runs approximately horizontally under this hexagonal nut-shaped adapter element.

It follows from the above that, after the first working step in the implanting is concluded, namely the insertion of the implant body into the jaw, a gingiva former is also installed simultaneously, and an impression post can be mounted on this gingiva former. This means that even after the first working step, it is possible to be able to make the impression for the design of the later dental prosthesis.

Here, a basic advantage of the method according to the invention is that the latter can be implemented with a small number of components and that the accommodations and connecting adapters that correspond to one another can be designed uniformly even when, for example, the basic shaping of the implant body can certainly vary both in its length and in its diameter. This is necessary to match the implant to the conditions in a patient's jaw.

This means that an implant body with a 6.5 mm diameter has—in a suitable design of the invention—the same inside threaded hole as well as the same hexagonal accommodation, as is provided in, for example, an implant body, which has only a 4.5 mm diameter. In this way, it is already ensured that the gingiva former in its basic design can be inserted into any implant body to always be held there with the same attachment screw.

The same can be said for the connection between impression posts and gingiva formers. Owing to the basic design of the gingiva former, independently of the implants, it is also possible to operate always with a uniform adapter shape of the impression post. Here, a variety of implants is thus to be produced with a minimum number of designs of the implant system, although variations, for example in the height of the gingiva former, can certainly be undertaken to be able to operate according to the patient's different organic basic requirements.

In an especially advantageous design of this invention, it is provided to introduce a basic starting design of the implant, namely the connection from the externally threaded implant body to screw into the jaw as well as mounted gingiva formers with inside fastening screws already with a mounted tool for screwing into the jaw in a structural basic unit for the first working step. This means the implant body with the mounted gingiva former that is stacked on the corresponding inserting tool is already arranged in a sterile accommodating container.

This in turn has the essential advantage that in this way, manually handling the section of the implant that is inserted into the jaw as well as the gingiva former that comes into contact with the gum can be avoided, since the implant body with a gingiva former does not have to be touched to perform the insertion process. Rather, the screwing tool can be removed from the container or taken out of the container directly with the gingiva former and implant bodies already mounted thereon. A clear improvement to the guarantee of sterile handling of the implant components can thus be achieved. Also, the positive engagement of the tool end in the gingiva former can be secured in addition here by a groove-spring connection, as was already described for the impression posts.

To conclude the procedure, after the healing process it is now only necessary to detach the gingiva former by loosening the inside fastening screw from the implant and replacing it with a corresponding abutment body, which acts as a seating for the permanent dental prosthesis.

In this connection, it is advantageous that this abutment body in the connecting area to the implant is designed analogously to the gingiva former, i.e., is designed in its lower section in the shaping analogously to the gingiva former and thus also engages in the, for example, hexagonal accommodation of the inside surface of the implant. Moreover, with the same fastening screw of this abutment body, in turn it can be fastened in the implant, which has become attached to the implant even before the gingiva former.

This results in that as early as in the second working step, the corresponding measures for permanent insertion of the dental prosthesis can be performed by avoiding the several intermediate working steps that are mentioned above. In this connection, it can also be seen as a basic advantage that owing to the reduction in the number of working steps, unintentional loosening of the implant that is screwed into the jaw can be avoided.

Below, the invention is explained based on several figures.

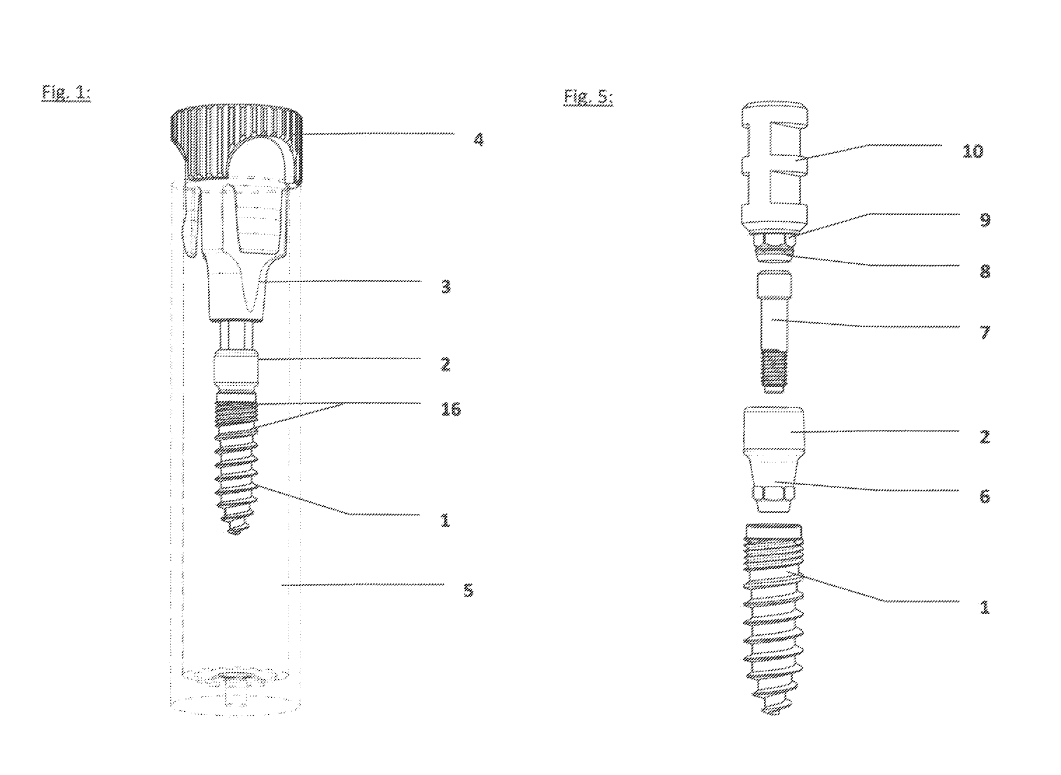

FIG. 1 shows the basic design of the implant system that consists of the lower implant body 1 with external threading 16 and the gingiva former 2 that is already mounted on the latter, which had already been pushed onto the tool 3 for screwing the implant 1 into the jaw. Here, the outside contour of a tubular receptacle 5 is shown for this basic design, since the basic design had been previously prepared in a sterile packaging for the handling. Since the top side of the screwing tool 3 is simultaneously the closure and the cover of the storage container 5, it is conceivably easy to ensure that contact between the implant 1 and the gingiva former 2 is avoided during handling, since only the upper area of the tool body 3 is grasped and the tube 5 has be to detached from the basic structure to release the implant body 1 for screwing it in.

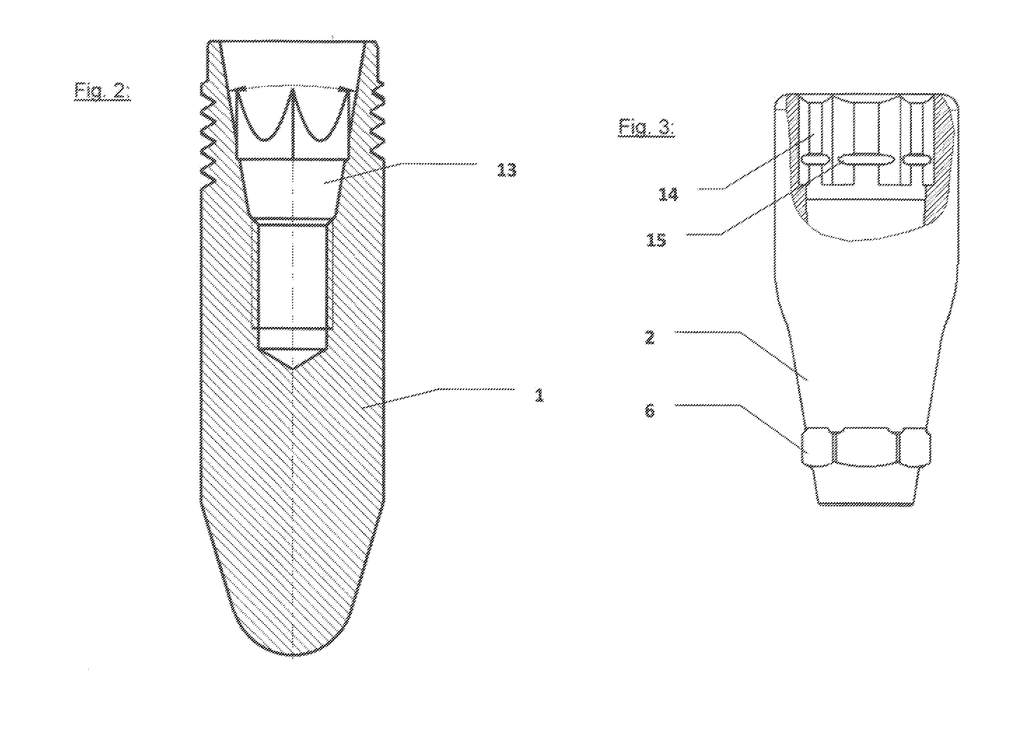

FIG. 2 now shows a cross-section through the implant body 1 with a corresponding inside accommodation 13 for the lower section of the gingiva former 2 as well as a corresponding fastening screw 7. Here, in the upper area of the hollow space in the implant 1, the hexagonal basic shape 13 is visible, which corresponds to the hexagonal outside shape 6 in the lower area of the gingiva former 2, as is shown in FIG. 3.

In this connection, the gingiva former 2 has inventive and novel features. The latter consist of, on the one hand, the hexagonal outside contour 6 in the lower section of the gingiva former 2 and also the analogously designed inside contour 14 in the upper section of the gingiva former 2, which is used as the application surface for the screwing tool 3. Moreover, the groove 15, running approximately horizontally on the inside in the upper section of the gingiva former 2, for accommodating a fastening projection 8 on the underside of the impression post 10, as the latter is shown in FIG. 4, is depicted in the drawing.

In this connection, the impression post 10 according to FIG. 4 has an underside connecting adapter 9 to the gingiva former 2, which is shaped hexagonally, designed corresponding to a hexagonal nut body in its outside contour. Below this hexagonal basic shape, the rotating fastening spring 8 is visibly engaged in the inside groove 15 in the gingiva former 2. Thus, a positive connection to the gingiva former 2 can be produced.

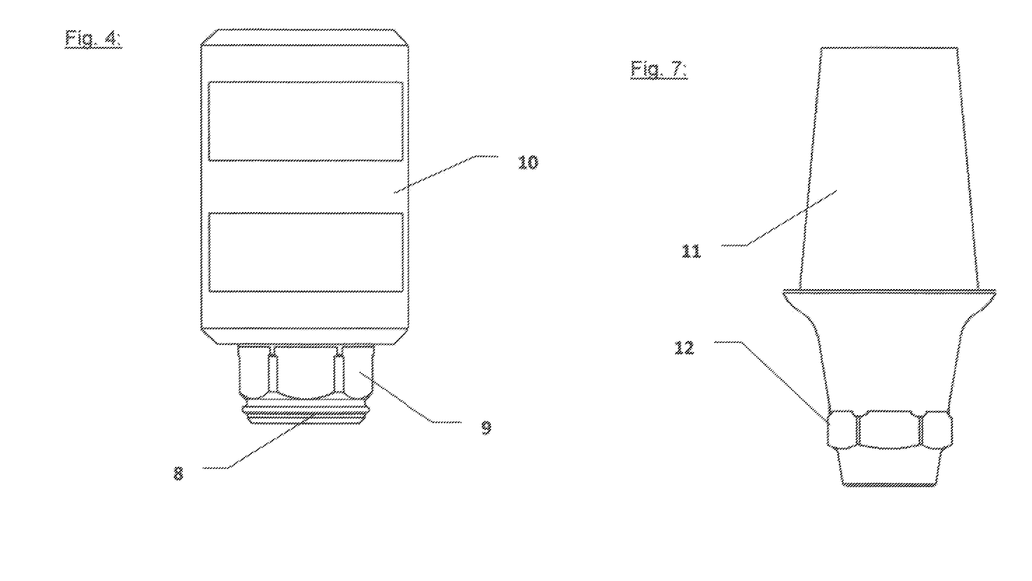

FIG. 5 shows the components implant body 1, gingiva former 2, inside screw 7 as well as impression post 10 arranged above one another in an exploded view to illustrate how these parts are placed in one another.

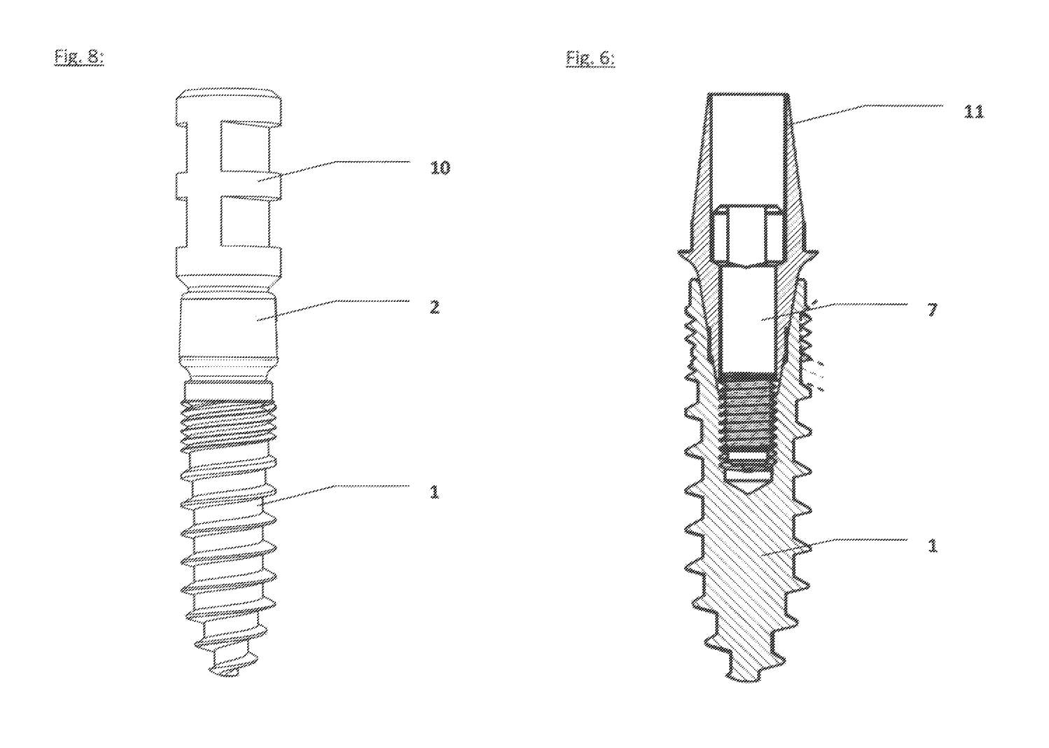

This is also illustrated by a section of FIG. 6 that depicts the later design state of the abutment body 11 in the implant 1. In this figure, it can be seen that the abutment body 11 is inserted into the implant body 1 analogously to the gingiva former 2 and is connected to the latter by means of a fastening screw 7. FIG. 7 shows this abutment body 11 with the hexagonal connecting area 12 in the lower section.

Finally, in FIG. 8, the arrangement of the impression post 10 on the gingiva former 2 is shown, which for its part is fastened to the implant body 1.

1. Two-part implant system for inserting dental prostheses that comprises an implant body (1) that is screwed into the jaw as well as an abutment body (11), carrying the dental prosthesis and fastened to this implant body (1),
characterized in that
A gingiva former (2) is fastened in a detachable manner even before being screwed into the implant body (1),
And at least one positive connection exists between the gingiva former (2) and the implant body (1),
And the gingiva former (2) has an accommodation on the top side for accommodating a tool (3) for screwing the implant body (1) with a mounted gingiva former (2) into the jawbone.

2. Two-part implant system according to claim 1, wherein the gingiva former (2) that is mounted and attached to the implant (1) is already mounted on a tool (3) as a first structural basic unit of the implant system or an adapter element in a tool for inserting the implant body (1) into the jaw is arranged in a sterile packaging for the implant process.

3. Two-part implant system according to claim 2, wherein the tool (3) or the adapter element to the tool for inserting the implant body (1) into the jaw simultaneously forms the closure of the sterile packaging (5) for the implant body (1) with the gingiva former (2).

4. Two-part implant system according to claim 1 or 2, wherein
The implant body (1) has an inside threaded hole (17) for accommodating a fastening screw (7) for connecting to the gingiva former (2) and later to an abutment body (11), and
In its upper section, moreover, it has an inside contour shaping (13) that corresponds to an analogous outside contour shaping (6, 12) in the lower section of the gingiva former (2) and an abutment body (11) that is to be inserted later, so that the outside contour (6, 12) of the lower section of the gingiva former (2) and later the abutment body (11) positively engages in this inside contour (13) in the upper section of the implant body (1).

5. Two-part implant system according to claim 3, wherein
The inside contour (13) in the upper section of the implant body (1) is designed as a hexagonal inside shape,
In which a hexagonal outside contour (6, 12) positively engages on the lower section of the gingiva former (6) as well as the abutment body (11).

6. Two-part implant system according to one of the preceding claims, wherein the inside hole (17) and the inside contour (13) of the implant body (1) remains constant independently of its height and diameter, and thus independently of these outside shapes of the implant body (1), it is suitable for connecting to the corresponding outside contours (6, 12) of the gingiva former (2) and the abutment body (11).

7. Two-part implant system according to one of the preceding claims, wherein
In its upper section, the gingiva former (2) has an inside circumferential groove (15),
Which corresponds to an outside rotating spring (8) on an impression post (10) that is to be inserted in this gingiva former (2) for a positive connection between the gingiva former (2) and the impression post (10),
Whereby the impression post (10) has an underside adapter section (9), which also has an outside contour that corresponds to the inside contour (6) of the upper accommodation in the gingiva former (2).

8. Method for inserting the dental prosthesis by means of a two-part implant system through the screwing-in of an implant body (1), which is used as a fastener for the dental prosthesis that is to be mounted, wherein after pre-drilling a hole into the jaw of the patient, a simultaneous screwing-in of an implant body (1) is carried out on this fastened gingiva former (2), whereby the tool (3) that is used engages in an accommodation of the gingiva former (2).

9. Method for inserting the dental prosthesis by means of a two-part implant system according to claim 7, wherein immediately after the screwing-in procedure of the implant (1), the tool (3) is removed from the gingiva former (2) and an impression post (10) is inserted positively into the gingiva former (2) and an impression for the production of the dental prosthesis is removed.

10. Pre-fabricated implant product that comprises:
a) A sterile accommodating vessel (5) with a top-side accommodating opening,
b) An implant body (1) with a gingiva former (2) fastened on the latter with a top-side accommodation for engaging a tool (3),
c) A tool (3) that engages in the gingiva former (2) or an adapter element to a tool that is designed in such a way that it is seated in a manner that cuts off air on the accommodating opening of the accommodating vessel (5) or is connected in a detachable manner to a cover that closes the accommodating opening.
